(19) United States
(12) Patent Application Publication
(10) Pub. No.: US 2024/0317640 A1
(43) Pub. Date: Sep. 26, 2024

(54) Method for preparing cover substrate

(71) Applicant: InnoLux Corporation, Miao-Li County (TW)

(72) Inventors: Ying-Yao TANG, Miao-Li County (TW); Chin-Lung TING, Miao-Li County (TW)

(21) Appl. No.: 18/677,562

(22) Filed: May 29, 2024

Related U.S. Application Data
(63) Continuation of application No. 17/367,031, filed on Jul. 2, 2021.
(60) Provisional application No. 63/117,095, filed on Nov. 23, 2020.

(51) Int. Cl. C03C 17/34; C03C 23/00

(52) U.S. Cl. CPC C03C 17/3417; C03C 23/0075; C03C 2217/73; C03C 2217/76; C03C 2218/155; C03C 2218/31; C03C 2218/322

(57) ABSTRACT

A method for preparing a cover substrate is provided. The method includes the following steps: providing a substrate with an anti-reflection film formed thereon, wherein the anti-reflection film includes a first layer, and the first layer includes silicon oxide; and treating the first layer of the anti-reflection film with fluoride-based plasma to form a hydrophobic layer on the first layer, wherein a fluorine-containing radical in the fluoride-based plasma is reacted with the silicon oxide in the first layer to form the hydrophobic layer, wherein the fluoride-based plasma is decomposed from a fluoride-based compound by using microwave, and the fluoride-based compound includes NF₃ or SF₆.

### CROSS REFERENCE TO RELATED APPLICATION

This application claims the benefit of filing date of U.S. Provisional Application Ser. No. 63/117,095 filed Nov. 23, 2020 under 35 USC § 119(e)(1).

This application is a continuation (CA) of U.S. Patent application for “Method for preparing cover substrate”, U.S. application Ser. No. 17/367,031 filed Jul. 2, 2021.

### BACKGROUND

### 1. Field

The present disclosure related to a method for preparing a cover substrate. More specifically, the present disclosure relates to a method for preparing a cover substrate with hydrophobicity.

### 2. Description of Related Art

The common anti-smudge or anti-fingerprint materials are the organic polymers with fluorine functional groups. Conventionally, these materials are bonded with the material of the substrate via high temperature dehydration reaction by the spray or evaporation process.

When the anti-smudge or anti-fingerprint layer is formed by the spray process, additional spray and oven machines have to be used for surface-treating the anti-reflection film.

When the anti-smudge or anti-fingerprint layer is formed by the evaporation process, even though the evaporation device can be integrated into the equipment for forming the anti-reflection film, the equipment has to be expanded and the high-temperature manufacturing process is still required. In addition, the anti-smudge or anti-fingerprint materials may adhere onto the chamber and the jig during the evaporation process, resulting in the pollution or defect on the product.

Therefore, it is desirable to provide a novel method to solve the problem of the spray or evaporation process.

### SUMMARY

The present disclosure provides a method for preparing a cover substrate, wherein the method comprises the following steps: providing a substrate with an anti-reflection film formed thereon, wherein the anti-reflection film comprises a first layer, and the first layer comprises silicon oxide; and treating the first layer of the anti-reflection film with fluoride-based plasma to form a hydrophobic layer on the first layer, wherein a fluorine-containing radical in the fluoride-based plasma is reacted with the silicon oxide in the first layer to form the hydrophobic layer, wherein the fluoride-based plasma is decomposed from a fluoride-based compound by using microwave, and the fluoride-based compound comprises NF₃ or SF₆.

Other novel features of the disclosure will become more apparent from the following detailed description.

### BRIEF DESCRIPTION OF THE DRAWINGS

FIG. 1 is a block diagram showing a method for preparing a cover substrate of the present disclosure.

FIG. 2A to FIG. 2C are cross-sectional views showing a process for preparing a cover substrate according to some embodiments of the present disclosure.

### DETAILED DESCRIPTION OF EMBODIMENT

Different embodiments of the present disclosure are provided in the following description. These embodiments are meant to explain the technical content of the present disclosure, but not meant to limit the scope of the present disclosure. A feature described in an embodiment may be applied to other embodiments by suitable modification, substitution, combination, or separation.

It should be noted that, in the present specification, when a component is described to comprise an element, it means that the component may comprise one or more of the elements, and it does not mean that the component has only one of the element, except otherwise specified.

Moreover, in the present specification, the ordinal numbers, such as “first” or “second”, are used to distinguish a plurality of elements having the same name, and it does not means that there is essentially a level, a rank, an executing order, or an manufacturing order among the elements, except otherwise specified. A “first” element and a “second” element may exist together in the same component, or alternatively, they may exist in different components, respectively. The existence of an element described by a greater ordinal number does not essentially means the existence of another element described by a smaller ordinal number.

In the present specification, except otherwise specified, the feature A “or” or “and/or” the feature B means the existence of the feature A, the existence of the feature B, or the existence of both the features A and B. The feature A “and” the feature B means the existence of both the features A and B. The term “comprise(s)”, “comprising”, “include(s)”, “including”, “have”, “has” and “having” means “comprise(s)/comprising but is/are/being not limited to”.

Moreover, in the present specification, the terms, such as “top”, “upper”, “bottom”, “front”, “back”, or “middle”, as well as the terms, such as “on”, “above”, “over”, “under”, “below”, or “between”, are used to describe the relative positions among a plurality of elements, and the described relative positions may be interpreted to include their translation, rotation, or reflection.

Furthermore, the terms recited in the specification and the claims such as “above”, “over”, or “on” are intended not only directly contact with the other element, but also intended indirectly contact with the other element. Similarly, the terms recited in the specification and the claims such as “below”, or “under” are intended not only directly contact with the other element but also intended indirectly contact with the other element.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those known in the art, the background of the present disclosure or the context of the present specification, and should not be read by an ideal or over-formal way.

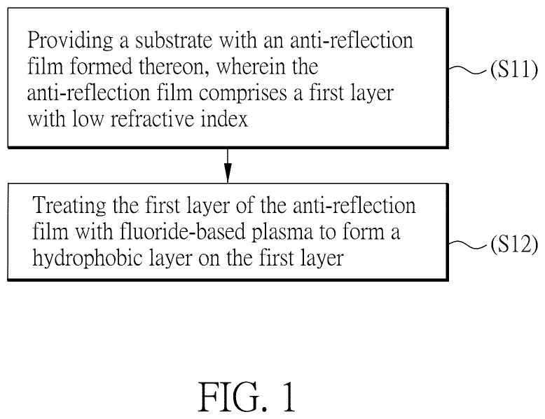

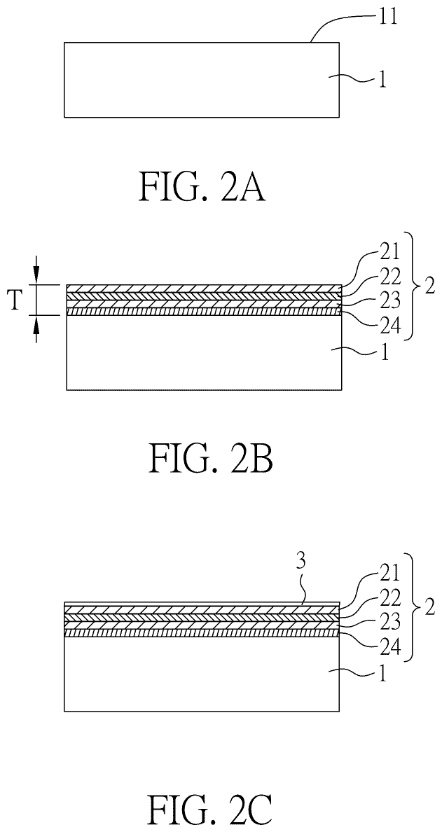

FIG. 1 is a block diagram showing a method for preparing a cover substrate of the present disclosure. FIG. 2A to FIG. 2C are cross-sectional views showing a process for preparing a cover substrate according to some embodiments of the present disclosure.

In the step (S11), as shown in FIGS. 2A and 2B, a substrate 1 is with an anti-reflection film 2 formed thereon is provided, wherein the anti-reflection film 2 comprises a first layer 21 with low refractive index.

In the step (S12), as shown in FIG. 2C, the first layer 21 of the anti-reflection film 2 is treated with fluoride-based plasma to form a hydrophobic layer 3 on the first layer 21.

Hereinafter, the process for forming the anti-reflection film 2 is described in detail.

As shown in FIG. 2A, a substrate 1 is provided. Herein, the substrate 1 may be a non-flexible substrate, a flexible substrate, a thin film or a combination thereof. The materials of the substrate 1 may comprise glass, quartz, silicon wafer, sapphire, polycarbonate (PC), polyimide (PI), polypropylene (PP), polyethylene terephthalate (PET), other suitable material, or a combination thereof; but the present disclosure is not limited thereto. When the substrate 1 is a thin film, the thin film may be a water barrier film or an encapsulating water barrier film formed by laminated inorganic-organic-inorganic (I-O-I) insulating layers.

In the present disclosure, the anti-reflection film 2 may be formed on the substrate 1 by a physical vapor deposition (PVD) process. For example, the anti-reflection film 2 may be formed by a sputtering process, but the present disclosure is not limited thereto.

The substrate 1 is placed in a chamber for PVD, and the substrate 1 is cleaned with plasma (for example, argon plasma) before the deposition process. The deposition process is briefly described below.

Firstly, additional energy is provided to cause gas discharge phenomenon, and the gas (for example, argon) is ionized to form charged ions. The charged ions are accelerated by an electric field and hit a target (i.e., Bombard) to shoot out a trace amount of target atoms and simultaneously generate secondary electrons. The target atoms reach the surface 11 of the substrate 1 with a certain kinetic energy to form a film comprising target elements on the surface 11 of the substrate 1. Then, oxygen, nitrogen or a combination thereof is introduced into the chamber to react with the target atoms deposited on the surface 11 of the substrate 1 to form an oxide, a nitride or an oxynitride of the target elements.

Then, the aforesaid deposition process is repeated to form plural layers until the anti-reflection film 2 has a desired thickness. In the present disclosure, the thickness T of the anti-reflection film 2 may be ranged from 500 nm to 1500 nm (500 nm≤T≤1500 nm). For example, the thickness T of the anti-reflection film 2 may be: 700 nm≤T≤1300 nm, 800 nm≤T≤1200 nm, 900 nm≤T≤1100 nm or 950 nm≤T≤1050 nm, but the present disclosure is not limited thereto . . . .

In the present embodiment, as shown in FIG. 2B, the anti-reflection film 2 comprises a first layer 21 with low refractive index. The anti-reflection film 2 further comprises a second layer 22 with high refractive index (greater than refractive index of the first layer), and the second layer 22 is disposed between the substrate 1 and the first layer 21. The anti-reflection film 2 further comprises a third layer 23 with low refractive index, and the third layer 23 is disposed between the substrate 1 and the second layer 22. The anti-reflection film 2 further comprises a fourth layer 24 with high refractive index (greater than refractive index of the first layer), and the fourth layer 24 is disposed between the substrate 1 and the third layer 23. Herein, the first layer 21 and the third layer 23 respectively have a refractive index (n1) less than 1.5 (n1<1.5), and the second layer 22 and the fourth layer 24 respectively have a refractive index (n2) more than 1.5 and less than 3.0 (1.5<n2<3.0). Thus, the anti-reflection film 2 of the present embodiments comprises four layers with layers having low refractive index and high refractive index alternately laminated. However, the present disclosure is not limited thereto. In some embodiments of the present disclosure, the anti-reflection film 2 may comprise more than four layers, as long as these layers are formed by layers having low refractive index and high refractive index alternately laminated.

In the present embodiment, the first layer 21 and the third layer 23 may respectively comprise silicon oxide (SiO₂), and the refractive index of silicon oxide is about 1.45˜1.48. The second layer 22 and the fourth layer 24 may respectively comprise niobium oxide (Nb₂O₅), titanium oxide (TiO₂), tantalum oxide (Ta₂O₅) or silicon oxynitride (SiON_{X}), and the materials for the second layer 22 and the fourth layer 24 can be the same or different. The refractive index of niobium oxide is about 2.1˜2.4, the refractive index of titanium oxide is about 2.2˜ 2.5, the refractive index of tantalum oxide is about 2˜2.3, and the refractive index of silicon oxynitride is about 1.6˜1.7.

Hereinafter, the process for forming the hydrophobic layer 3 is described in detail.

As shown in FIG. 2B, after forming the anti-reflection film 2, the anti-reflection film 2 may be selectively cleaned with plasma (for example, argon plasma). After cleaning, a fluoride-based compound is introduced into the same chamber for PVD, followed by turning on the plasma generator, and the fluoride-based compound is decomposed by microwave to generate fluoride-based plasma. Then, the fluorine-containing radicals in the fluoride-based plasma are reacted with the silicon oxide comprised in the first layer 21 to form the hydrophobic layer 3. For example, the fluorine-containing radicals may replace the hydrogen atoms or the hydroxyl groups of the silicon oxide to form fluorine-containing substituents bonding to the silicon elements of the silicon oxide.

In the present embodiment, the power (W1) of the microwave used for generating the fluoride-based plasma may be, for example, ranging from 1200 W to 1800 W (1200 W≤W1≤1800 W). The gas flow (R) of the fluoride-based compound for forming the fluoride-based plasma may be, for example, ranged from 400 sccm to 600 sccm (400 sccm≤R≤600 sccm). In addition, the first layer 21 of the anti-reflection film 2 is treated with the fluoride-based plasma at a pressure (P), for example, ranging from 90 Pa to 150 Pa (90 Pa≤P≤150 Pa). However, the parameters used for forming the anti-reflection film 2 are not limited to those described above, and may be adjusted according to the need.

In the present embodiment, the fluoride-based compound used for generating the fluoride-based plasma may be C₁₋₈ alkane substituted with fluorine, C₂₋₈ alkene substituted with fluorine, C₂₋₈ alkyne substituted with fluorine, nitrogen trifluoride, sulfur hexafluoride, or a combination thereof. In some embodiments of the present disclosure, the fluoride-based compound may be C₁₋₆ alkane substituted with fluorine, C₂₋₆ alkene substituted with fluorine, C₂₋₆ alkyne substituted with fluorine, nitrogen trifluoride, sulfur hexafluoride, or a combination thereof. In further some embodiments of the present disclosure, the fluoride-based compound may be C₁₋₄ alkane substituted with fluorine, C₂₋₄ alkene substituted with fluorine, C₂₋₄ alkyne substituted with fluorine, nitrogen trifluoride, sulfur hexafluoride, or a combination thereof. Herein, alkane substituted with fluorine refers to the alkane in which one to all of the hydrogen atoms in the alkane are substituted with fluorine atoms. Similarly, alkene substituted with fluorine refers to the alkene in which one to all of the hydrogen atoms in the alkene are substituted with fluorine atoms. Similarly, alkyne substituted with fluorine refers to the alkyne in which one to all of the hydrogen atoms in the alkyne are substituted with fluorine atoms. Specific examples of the fluoride-based compound capable of generating the fluoride-based plasma may include, but are not limited to, CF₄, CHF₃, C₂F₆, C₃F₈, C₄F₈, NF₃ or SF₆.

In the present embodiment, a radio-frequency bias may be provided when treating the first layer 21 of the anti-reflection film 2 with the fluoride-based plasma. The radio-frequency bias may lead the fluorine-containing radicals in the direction toward the first layer 21, and thus the uniformity of the formed hydrophobic layer 3 may be improved. The radio-frequency bias may be provided by applying on a stage (not shown in the figure) for carrying the substrate 1. In addition, the radio-frequency bias is provided with a radio-frequency having a power (W2), for example, ranged from 200 W to 300 W (200 W≤W2≤300 W); but the present disclosure is not limited thereto.

After the aforementioned process, the hydrophobic layer 3 is formed on the anti-reflection film 2. Herein, the formed hydrophobic layer 3 has a contact angle (θ) over than 100 degrees (θ>100°). For example, the contact angle (θ) of the hydrophobic layer 3 may be: 100°<θ<150°, 100°<θ<140°, 100°<θ<130°, 100°<θ<120°, or 100°<θ<115°. The fluorine-containing substituents bonding to the silicon elements of the silicon oxide can provide hydrophobicity, so the hydrophobic layer 3 may have the anti-smudge or anti-fingerprint effect.

As shown in FIG. 2C, the substrate 1 with the anti-reflection film 2 and the hydrophobic layer 3 formed thereon may be used as a cover substrate for an electronic device. The electronic device may include a display device, an antenna device, a sensing device, a touch display device, a curved display device, or a free shape display device, but is not limited thereto. The electronic device may be a bendable or flexible electronic device. The electronic device may include, for example, liquid crystal, light emitting diode, fluorescence, phosphor, other suitable display media, or a combination thereof, but is not limited thereto. The light emitting diode may include, for example, an organic light emitting diode (OLED), a sub-millimeter light emitting diode (mini LED), a micro light emitting diode (micro LED) or a quantum dot (QD) light emitting diode (for example, QLED, QDLED) or other suitable materials or a combination thereof, but is not limited thereto. The display device may include, for example, a tiled display device, but is not limited thereto. The antenna device may be, for example, a liquid crystal antenna, but is not limited thereto. The antenna device may include, for example, a tiled antenna device, but is not limited thereto. It should be noted that the electronic device may be a combination of the foregoing, but is not limited thereto. In addition, the appearance of the electronic device may be rectangular, circular, polygonal, a shape with curved edges, or other suitable shapes. The electronic device may have peripheral systems such as a driving system, a control system, a light source system, a shelf system, etc., to support a display device, an antenna device, or a tiled device.

### Test Example

In the present test example, the cover substrate with the hydrophobic layer (as shown in FIG. 2C) and the cover substrate without the hydrophobic layer (as shown in FIG. 2B) are evaluated.

Herein, as shown in FIG. 2A, a substrate 1 which is a glass substrate was provided. The substrate 1 was placed in the chamber of the PVD equipment, followed by cleaning with argon plasma. Then, additional energy was provided to generate charged ions of argon. The charged ions of argon were accelerated by the electric field and hit the Nb target to eject Nb atoms and generate secondary electrons at the same time. The Nb atoms reached the surface 11 of the substrate 1 and deposited to form a Nb film. Then, oxygen was introduced into the chamber to react with the Nb elements of the Nb film to form Nb₂O₅. Thus, the fourth layer 24 shown in FIG. 2B was formed.

Then, the charged ions of argon were accelerated by the electric field and hit the Si target to eject Si atoms and generate secondary electrons at the same time. The Si atoms reached the fourth layer 24 and deposited to form a Si film. Then, oxygen was introduced into the chamber to react with Si elements of the Si film to form SiO₂. Thus, the third layer 23 shown in FIG. 2B was formed.

The process for forming the fourth layer 24 was repeated again to form the second layer 22 on the third layer 23, and the process for forming the third layer 23 was repeated again to form the first layer 21 on the second layer 22. Thus, the anti-reflection film 2 was formed on the substrate 1.

Next, the anti-reflection film 2 was cleaned with argon plasma. After cleaning, C₃F₈ gas (500 sccm) was introduced into the same chamber of the PVD equipment, followed by turning on the plasma generator. The C₃F₈ gas was decomposed by microwave (1500 W). The bias RF (1500 W) was also applied. The surface of the first layer 21 of the anti-reflection film 2 was treated with the C₃F₈ plasma at 120 Pa for 60 seconds. Thus, the hydrophobic layer 3 was formed on the anti-reflection film 2.

The contact angles of the anti-reflection film 2 and the hydrophobic layer 3 were measured by using the contact angle meter, and the measurement results are listed in the following Table 1. In Table 1, “Before” means the film before the fluoride treatment (i.e., the anti-reflection film 2), “After” means the film after the fluoride treatment (i.e., the hydrophobic layer 3), “Pos 1” to “Pos 3” means the first position to the third position, “Avg” means the average contact angle, “Max” means the maximum contact angle, and “Min” means the minimum contact angle.

TABLE 1

| Wet contact angle | | | | | | |
|---|---|---|---|---|---|---|
| (degrees) | Pos 1 | Pos 2 | Pos 3 | Avg | Max | Min |
| Before | 15.2 | 16.5 | 16.5 | 16.1 | 16.5 | 15.2 |
| After | 109.1 | 109.1 | 110.3 | 109.5 | 110.3 | 109.1 |

According to the results shown in Table 1, the hydrophobic layer 3 has the contact angle over than 100 degrees, but the anti-reflection film 2 has the contact angle less than 20 degrees. Thus, the hydrophilic anti-reflection film 2 can be converted into the hydrophobic layer 3 by fluoride treatment.

Although the present disclosure has been explained in relation to its embodiment, it is to be understood that many other possible modifications and variations can be made without departing from the spirit and scope of the disclosure as hereinafter claimed.

What is claimed is:

1. A method for preparing a cover substrate, comprising the following steps:
providing a substrate with an anti-reflection film formed thereon, wherein the anti-reflection film comprises a first layer, and the first layer comprises silicon oxide; and
treating the first layer of the anti-reflection film with fluoride-based plasma to form a hydrophobic layer on the first layer, wherein a fluorine-containing radical in the fluoride-based plasma is reacted with the silicon oxide in the first layer to form the hydrophobic layer,
wherein the fluoride-based plasma is decomposed from a fluoride-based compound by using microwave, and the fluoride-based compound comprises NF₃ or SF₆.

2. The method of claim 1, wherein the first layer has a refractive index less than 1.5.

3. The method of claim 1, wherein the anti-reflection film further comprises a second layer, and the second layer has a refractive index more than 1.5 and less than 3.0 and is disposed between the substrate and the first layer.

4. The method of claim 3, wherein the second layer comprises niobium oxide, titanium oxide, tantalum oxide or silicon oxynitride.

5. The method of claim 3, wherein the anti-reflection film further comprises a third layer, and the third layer has a refractive index less than 1.5 and is disposed between the substrate and the second layer.

6. The method of claim 5, wherein the anti-reflection film further comprises a fourth layer, and the fourth layer has a refractive index more than 1.5 and less than 3.0 and is disposed between the substrate and the third layer.

7. The method of claim 1, wherein the microwave has a power ranging from 1200 W to 1800 W.

8. The method of claim 1, wherein the first layer of the anti-reflection film is treated with the fluoride-based plasma at a pressure ranging from 90 Pa to 150 Pa.

9. The method of claim 1, wherein a gas flow of the fluoride-based compound for forming the fluoride-based plasma is ranged from 400 sccm to 600 sccm.

10. The method of claim 1, wherein a radio-frequency bias is provided when treating the first layer of the anti-reflection film with the fluoride-based plasma.

11. The method of claim 10, wherein the radio-frequency bias is provided with a radio-frequency having a power ranged from 200 W to 300 W.

12. The method of claim 1, wherein the anti-reflection film is formed on the substrate by a physical vapor deposition process.

13. The method of claim 12, wherein the physical vapor deposition process is a sputtering process.

14. The method of claim 1, wherein a thickness of the anti-reflection film is ranged from 500 nm to 1500 nm.
